(19) United States
(12) Patent Application Publication
(10) Pub. No.: US 2016/0092883 A1
(43) Pub. Date: Mar. 31, 2016

(54) TIMELINE-BASED VISUALIZATION AND HANDLING OF A CUSTOMER

(71) Applicants: Jutta Weber, Mannheim (DE); Stef Huber, Berlin (DE); Fariba Sadri, Sandhausen (DE)

(72) Inventors: Jutta Weber, Mannheim (DE); Stef Huber, Berlin (DE); Fariba Sadri, Sandhausen (DE)

(21) Appl. No.: 14/502,137

(22) Filed: Sep. 30, 2014

(51) Int. Cl. G06Q 30/00

(52) U.S. Cl. CPC G06Q 30/016

(57) ABSTRACT

A system and method for navigating a customer management application hosted on an electronic device is provided. Using the customer management application, a user may review data from a plurality of applications and data sources. In addition, the data may be arranged along one or more timeline displays. For example, the system and method may display a timeline having first and second timescales, display one or more entries along the timeline, each of the entries containing one or more corresponding events, detect a user input though an input detector of the electronic device, and upon detecting the user input, vary the timeline according to the user input.

### FIELD OF INVENTION

The present invention generally relates to electronic customer management applications, and more particularly, relates to customer management applications that enable a user to navigate through a timeline illustrating customer events.

### BACKGROUND

In today's hyper information age, it is not uncommon to manage large amounts of electronically stored information. A variety of applications and application types have been developed to enable users to view, query, manipulate, and delete data stored at backend systems. For example, many existing applications have been developed to manage particular data objects such as databases, e-mail, calendars, tasks, etc.

Advances in computing technologies have enabled smaller devices, such as mobile phones and tablets, to execute more sophisticated functions and applications. As a result, people often utilize their mobile phones and tablets to perform many of the functions that they previously performed on their personal computers and laptops. For example, users now view websites, e-mail, and calendars on their mobile phones and tablets.

A drawback of smaller devices is their reduced display size. In order to maximize the display size of these smaller devices, touchscreen interfaces are often used. The use of a touchscreen eliminates the need for a separate keypad such that additional space can be dedicated to a display. In addition, touchscreens eliminate the need for a pointer object (e.g., arrow or cursor) within the display. Although touchscreens help to maximize display size on mobile phones and tablets, their small displays still present challenges to application developers.

Despite the decreasing size of electronic devices, existing applications and corresponding user interfaces continue to include increasing amounts of information. For example, calendar entries may include dense amounts of information. In addition, increased processing power has allowed application developers to implement more complex functions.

Although an end user may desire to perform a specific task, such as review a client relationship, conventional static user-interfaces require a user to review data from a plurality of applications and data sources. As a result, it may be difficult to quickly gather relevant customer information, especially when a user is interacting with a large or long-term customer. Accordingly, there is a need to provide dynamic user interfaces that enable a user to quickly obtain an overview of customer information.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram depicting an architectural overview of a networked system for generating dynamic user interfaces according to an example embodiment.

FIG. 2 illustrates a representative view of an electronic device having a customer management application according to an example embodiment of the present invention.

FIGS. 3(A) and 3(B) illustrate representative views of timeline displays according to example embodiments of the present invention.

FIG. 4 illustrates a method for navigating the timeline illustrated by a customer management application according to an example embodiment of the present invention.

FIG. 5 illustrates a representative architecture of an electronic device according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

A system and method for navigating a customer management application hosted on an electronic device is provided. Using the customer management application, a user may review data from a plurality of applications and data sources. Some example external data sources include news, press releases, and e-mail, and some example internal data sources include transactional information such as sales activities, quotations, and sales orders from customer resource management (CRM) and enterprise resource planning (ERP) systems. In addition, the data may be arranged along one or more timeline displays. Thus, data originating from multiple data sources may be arranged on a single timeline display. For example, the system and method may display a timeline having first and second timescales, display one or more entries along the timeline, each of the entries containing one or more corresponding events, detect a user input though an input detector of the electronic device, and upon detecting the user input, vary the timeline according to the user input.

User interfaces and associated methods for using an electronic device are described. The user interface may include a touchscreen, a gyroscopic, other acceleration device, keyboard, mouse, and/or other input/output devices. In some embodiments, the device is a portable electronic or communications device (e.g., a mobile phone or tablet). However, the electronic device is not limited to portable devices, but rather may also comprise stationary devices, such as a desktop computer. It should be understood that the user interfaces and associated methods may be applied to a variety of electronic devices, such as personal computers, laptops, and televisions, which may include one or more other physical user-interface devices, such as a keyboard, mouse, and/or touchscreen.

The electronic device may support a variety of applications, such as telephone, text messenger, and information management applications. The various applications that may be executed on the device may use at least one common physical user-interface device, such as a touchscreen. One or more functions of the user interface(s) as well as corresponding information displayed on the device may be adjusted and/or varied from one application to another and/or within a respective application. In this way, a common physical architecture of the device may support a variety of applications with user interfaces that are intuitive and transparent. In the discussion that follows, a customer management application is used as an example embodiment, but it should be understood that the user interface(s) and associated methods may be applied to other applications.

By implementing the dynamic interfaces according to embodiments of the present disclosure, users will be better equipped to access specific data and application functionality, and make more informed decision in real-time. The dynamic interfaces of the present disclosure avoid the problems associated with navigating through a plurality of applications and numerous menus to obtain customer information. As a result, users may more efficiently retrieve data and execute desired tasks.

A customer management application that enables a user to navigate time position and vary timescale is provided. In addition to using finger gestures on a touchscreen to change a time position and timescale, tilts and other movements of a portable electronic device may be detected and used to navigate a customer management application. In particular, a user may navigate a customer management application by moving the host electronic device. For example, a user may navigate to an earlier or later time position by tilting the electronic device to the left or right side, respectively. In another example, a user may shuffle through entries within a specified time range by moving the electronic device up or down. Alternatively, a user may zoom in and out of the timescale by moving the electronic device down or up, respectively. In yet another example, a motion on the touchscreen or sequence on a keypad (or other tactile device), may also be applied to navigate time position and timescale in a customer management application.

A user viewing the customer management application may vary the timescale. Using a user-interface of the electronic device, a user may change the timescale. In the case of a touch screen, the timescale may be changed according to a change of a distance separating two user selected points on the screen as at least one of the user selected points is moved by the user. In the case of an acceleration device, the timescale may be changed according to detected variations in tilt or device height. As the user zooms into and out of the timeline, a timescale that is displayed as part of the timeline may also be updated. For example, if a user zooms into a particular timescale showing several years worth of data in the timeline, the timescale may be updated to show fiscal quarters or calendar months instead of years. The entries that are shown in the timeline may also be updated so that they correspond to the selected zoomed in time period. A user using a touchscreen device may use at least two of their fingers to select and/or move the two points on the touchscreen.

In some instances, detailed information may be displayed for customer entries when a user zooms into the timeline whereas aggregated, consolidated, or more general information may be displayed when the user zooms out of the timeline. In some instances, the degree of zooming may depend on the separation distance between the two user selected points as the user moves one of the points. Alternatively, the degree of zooming may also depend on the detected change in the height of a portable electronic device, and zooming in may be achieved by moving the electronic device in the downward direction. In both instances, the timeline may be further zoomed into making it possible to zoom from displaying several years, to displaying only a few months, to only a few days, and so on by either spreading the two points further apart or moving them closer together. The reverse zoom may also be applied if the points are moved in the opposite direction by either moving them closer together or spreading them apart. Reverse zoom may also be achieved by detecting a move of the electronic device in an upward direction.

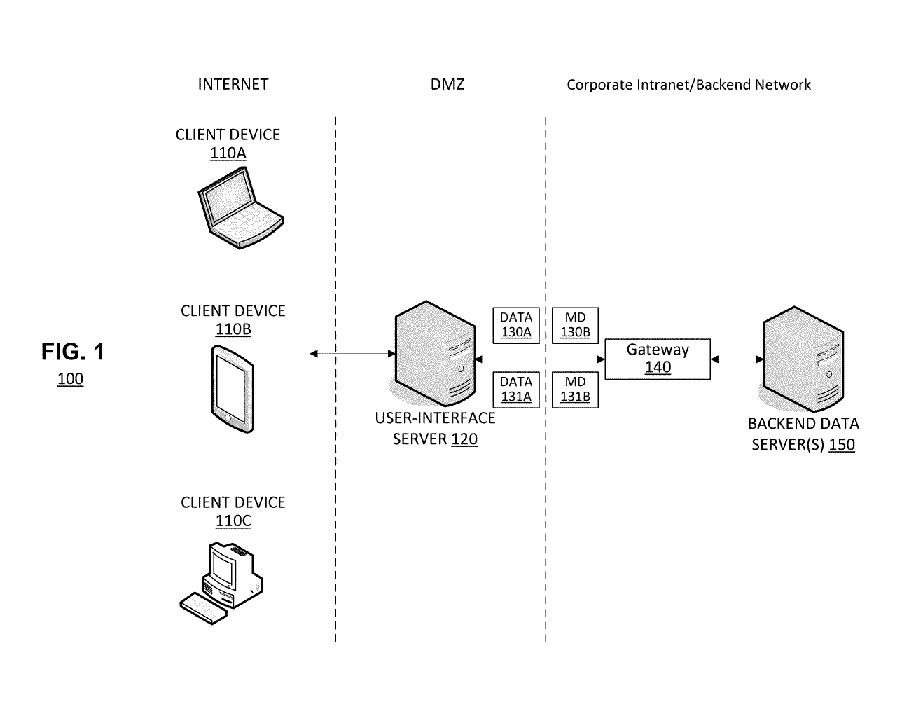

FIG. 1 is a system diagram depicting an architectural overview of a networked system 100 for generating dynamic user interfaces according to an example embodiment. The system 100 includes client devices 110A, 1108, 110C, UI (user interface) server 120, gateway 140, and backend data server(s) 150. Communications between components of the system 100 may utilize a variety of data transfer protocols, such as HTTP methods (e.g., get, post, put, and delete) or web socket, to query, interact, and manipulate data. In addition, the components of system 100 may be implemented using conventional and/or cloud networks.

As illustrated, the networked system 100 includes one or more client devices such as client devices 110A, 1108, 110C, being network accessible via an Internet connection, and connected to a UI server 120 in a network demilitarized zone (DMZ). Collectively, devices such as client devices 110A, 1108, 110C and UI server 120 may be referred to as a dynamic frontend system. Client devices 110A, 1108, 110C may include a variety of devices which may include, for example, a mobile device (e.g., mobile phone or a smartphone), a personal computer, a laptop, a tablet, or the like. Each of the client devices 110A, 1108, 110C is configured to transmit and receive data and metadata communications with the UI server 120. The data communications (e.g., 130 and 131) may be exchanged with backend data server(s) 150 via optional gateway 140.

The UI server 120 may be configured to transmit data 130A to an enterprise data system such as a backend server 150 in a corporate intranet/backend network. The optional gateway 140 may translate requests, such as data retrieval requests included in data 130A, to other proprietary protocols, such as remote function call (RFC). Alternatively, the functions of gateway 140 may be implemented at backend server(s) 150 such that it may directly receive requests. The backend server(s) 150 may be configured to process the request(s), retrieve data and/or perform data operations as an appropriate response to a request, and return a response for transmission back to the gateway 140. Again, the gateway 140 may be used to translate a proprietary protocol. The data response 131 may be transmitted from gateway 140 (which is located in the backend network) to the appropriate client device 110A, 1108, 110C via UI server 120.

UI server 120 may include a data handler adapted to retrieve data and/or metadata from the gateway 140 and/or backend server(s) 150. The metadata may include information about the type of the data (e.g., date, type of input field, read-only/editable, function, etc.) as well as information about the relevance of the data. Using the information gathered from backend server(s) 150, the UI server 120 may aggregate data from data server(s) 150. In addition, the UI server 120 may instruct a client device 110 to generate and render user interfaces in a dynamic manner.

Backend server(s) 150 may include internal and external data sources. Some example external data sources include a variety of media (e.g., news, press releases, etc.), e-mail, and the like. Example internal data sources may include transactional information such as sales activities, quotations, and sales orders from CRM and ERP systems. In some instances, the UI server 120 and/or gateway 140 may aggregate data from multiple backend servers. Thus, aggregated data may be presented along one or more timeline displays.

When using server-side UI technologies (e.g., Perl, SAP-WebDynpro, SAPGui, etc.), a UI server 120 may generate the UI code at runtime. However, depending on the UI technology, some embodiments may implement the functions of the UI server 120 on the client-side. For example, functions of the UI server 120 may be implemented at the client device 110A, 1108, 110C on a browser using HTML5/javascript/css, or on a device using ObjectiveC. Thus, in some implementations, use of UI server 120 is optional.

Gateway 140 may be located between the UI server 140 and the backend server(s) 150 to intercept data communications, such as data 130, 131. The gateway 140 acts as a middle party with both client and server functionality to handle communications in both directions. The gateway 140 may perform server functions, such as responding to data requests from client devices 110A, 1108, 110C. Data responses may be included in data 131A. The gateway 140 also performs client functions, such as forwarding incoming data requests from the client device (110A, 1108, 110C) to the backend server(s) 150. The gateway 140 may forward a data request 120 to the backend server(s) 150, and receive a corresponding data response 131. The data response 131 may be relayed to the UI server 120 as data 131A and metadata 131B.

After receiving the data response 131 from the gateway 140 (and correspondingly, from the backend server(s) 150), the gateway 140 can append metadata 131B to received data 131. Once the data response 131A, 131B is generated by gateway 140, the data response 131A, 131B may be returned to the client device 110A, 1108, 110C by UI server 120. As shown, response data 131A and response metadata 131B may be communicated from the gateway 140 to the UI server 130, for communication to the appropriate client device 110A, 1108, 110C.

Data relating to a group of users, such as peer groups, may relate to interactions with a single or multiple backend server(s) 150. Example groups may designate similarly situated users, such as employees of particular business units, managers, occasional consumers, business customers, etc. In another example, groups may be based upon the role of the user (e.g., sales rep, payroll admin, etc.).

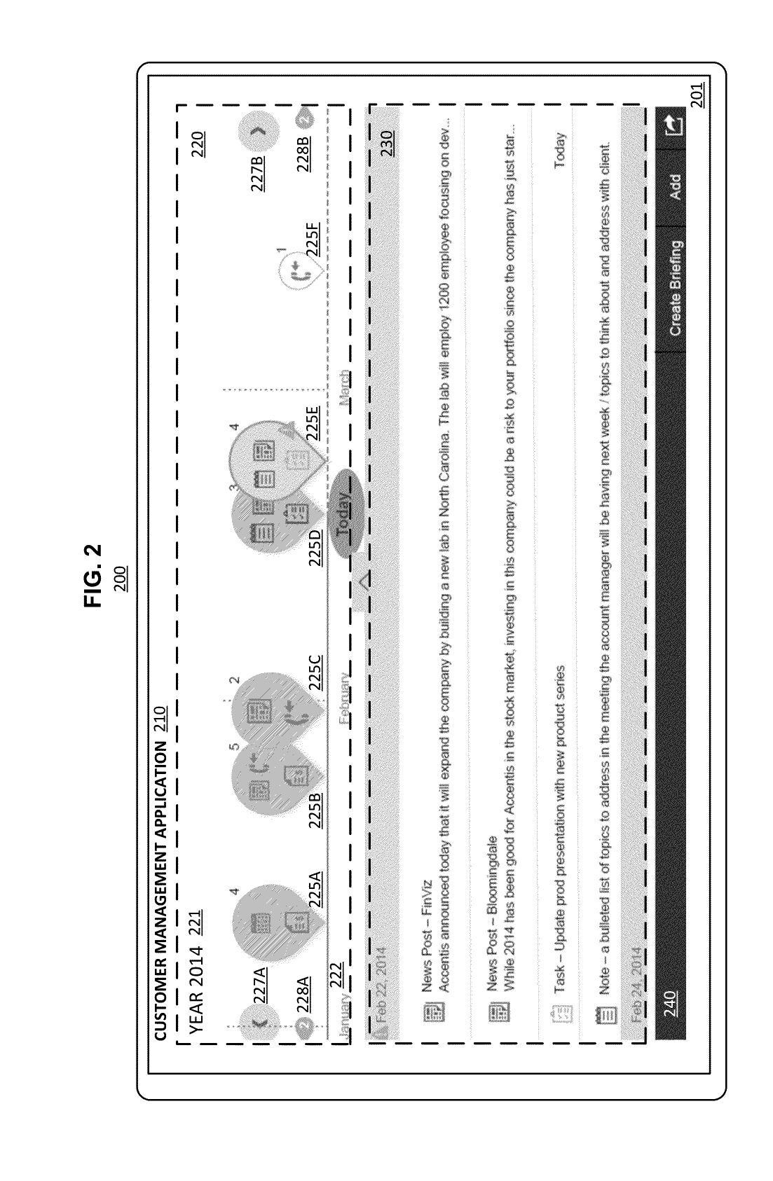

FIG. 2 illustrates a representative view of an electronic device having a customer management application 210 according to an example embodiment of the present invention. As shown in FIG. 2, an electronic device 200 includes a display, such as touchscreen interface 201 and customer management application 210 displayed thereon. Within the customer management application 210 may be timeline section 220, description section 230, and menu section 240.

The customer management application 210 may show a horizontal timeline in timeline section 220. The horizontal timeline may include a primary timescale 221 and a secondary timescale 222. Along the timeline, one or more entries 225A-F that fall within the selected time period may be displayed. Example entries include a variety of objects, such as media, appointments, telephone calls, notes, tasks, lead tasks, price quotations, opportunities, sales orders, etc. In some embodiments, the user may select that a subset of event types be displayed via menu section 240. Objects populating each of entries 225A-F may originate from one or more backend server(s).

A selected entry, say 225E, may be highlighted or otherwise visually depicted to indicate selection by a user. Once an event entry is selected, more detailed information associated with the entry may be displayed within description section 230. Past, present and future entries may also be visually distinguished. For example, future events may be displayed as dotted lines and/or with different colors or texture (e.g., transparent).

Entries 225A-F are depicted using a bubble shape, but other graphical representations are also feasible. Each of entries 225A-F may display one or more events for a particular day. In some embodiments, a predetermined number of events may be shown within a particular entry, such as three events. In such embodiments, an importance value may be calculated for each event such that more important events are previewed within the particular entry. The number next to (i.e., at the upper right) of each of the event entries 225A-F may be used to indicate the number of events occurring on a particular date.

In some instances, new entries may be added to the timeline section 210 by pressing and holding a finger or other object to a point in time along the timeline. When the user presses and holds (e.g., holds for 500 ms to 750 ms), an empty entry may be introduced to the timeline. In addition, a menu may be provided to add one or more of a variety of event types. After selecting an event to add, a window may be displayed to prompt the user to enter details for the added event. Here, the date field for the event may be pre-filled. Alternatively, new entries may be added via the add button within menu section 240.

Additionally, alert indicators such as a warning symbol may be used to identify upcoming events to a user. For example, an alert indicator may be used to identify an upcoming due date or an expiring price quote. Preview markers 228A and 228B may be used to identify how many past or upcoming alert indicators are within a predetermined period of the displayed timeline. By selecting preview markers 228A or 228B, the timeline may scroll to past or future periods of the timeline and automatically resize (i.e., zooms in or out) so that all alerts indicators are visible within the timeline section 220.

The customer management application 210 may include a zoomable area which may encompass the whole timeline or parts of the timeline where the user may use fingers or objects to zoom in or out of the timeline. A user may zoom in or out of the timeline using zoom buttons (e.g., +/−, not shown). Alternatively, a user may zoom in or out of the timeline by initially selecting first and second points (not shown) on the timeline with fingers or objects. The user may then drag one or more of their fingers to change the distance between the first point and the second point. The change in the distance separating the two points may determine whether to zoom in or out of the timeline and by what amount. In yet another alternative, the user may zoom in or out of the timeline by varying the height of the electronic device 200, as detected by a built-in acceleration device (not shown). The user may navigate the timeline using backward and forward time period selectors 227A and 227B. Alternatively, the time position may be changed by sliding the timeline using a finger or object. In yet another alternative, the time position may be changed by tilting or rotating the electronic device 200 to the left or right direction.

In some instances, whenever the timeline is readjusted, the entries and/or other content associated, such as events, within the timeline may also be reassessed for display in the timeline. Entries may be resized according to the zoom level and/or a different number of events may be displayed to make the entries and events more readable and/or selectable by a user.

The timescale shown in the timeline may be a multidimensional timescale including a primary timescale 221 and a secondary timescale 222. The secondary timescale 222 may have a unit of time that is a subset of the primary timescale 221. When a multidimensional timescale is changed, at least one of the primary timescale 221 and the secondary timescale 222 may be changed accordingly. For example, the primary timescale 221 may be fiscal quarters and the secondary timescale 222 may be months. When zooming out of this timeline view, the primary timescale may change from fiscal quarters to years.

In some instances, the secondary timescale 222 may be changed between different time units, such as from months to quarters. In other instances, the secondary timescale 222 may continue to show the same time unit, such as months, though the space allocated for time unit may be changed.

When zooming into or out of the customer management application 210, either or both of the primary timescale 221 and the secondary timescale 222 may be changed. In addition, the information about one or more of the entries 225A-F displayed on the screen may also change when zooming into or out. For example, in response to a user zooming into the timeline, additional information associated with each entry may be displayed in description section 230. This additional information may be displayed for those entries that are within the adjusted start date and the adjusted end date of the timeline. The additional information that is displayed may include any information about the activities, tasks, or events associated with a respective entry 225A-F. Information displayed on screen may also be consolidated if the user zooms out of the customer management application 210. For example, in response to a user zooming out of the timeline, entry information displayed in description section 230 may be consolidated to display less information on the screen.

In some embodiments, the current date (i.e., “Today”) may be displayed in a manner that differentiates it from other dates. Whenever the current date is displayed within the timeline, it may also function as a selectable button such that the user can quickly switch to the current date upon selection. If the current date is not within the displayed timeline, a “Today” button may be placed at a side of the timeline.

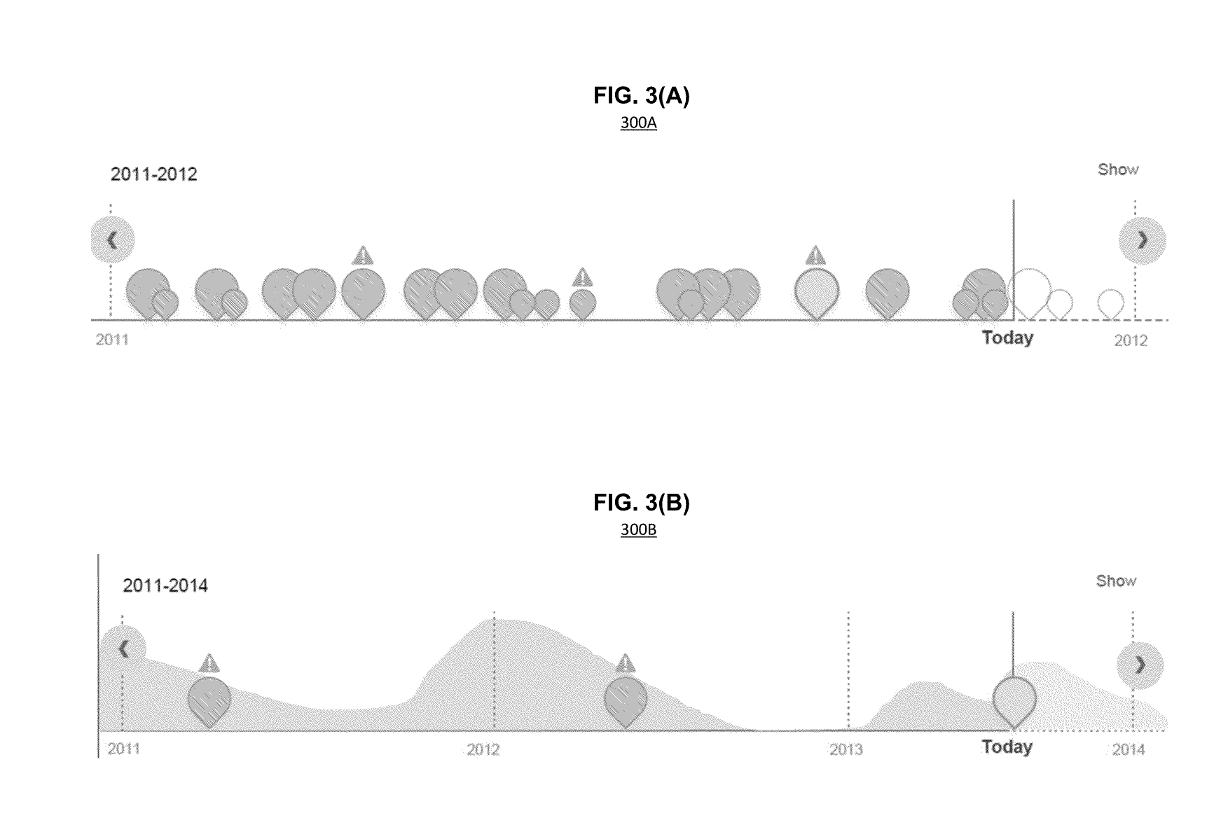

FIGS. 3(A) and 3(B) illustrate other representative views of timeline displays according to example embodiments of the present invention.

As shown in FIG. 3(A), entries are depicted without associated events. However, the size of the entry may be used to depict the number of events and/or the number of event types. In some instances, the example timeline of FIG. 3(A) may be automatically displayed when more than a predetermined number of entries, e.g. 10, are displayed within the time period.

Similarly, as shown in FIG. 3(B), events may be depicted using smoothed curve that estimates the number of events occurring at particular points along the timeline. Here, more important events may still be depicted as individual entries. The embodiment depicted in FIG. 3(B) may also be automatically displayed when more than a predetermined number of entries, e.g. 30, are displayed within the time period.

As compared to FIG. 2, a longer timeline is depicted in FIGS. 3(A) and 3(B). In other words, FIGS. 3(A) and 3(B) show a zoomed out view of the customer management application of FIG. 2. The view of FIG. 2 shows a timeline between January 2014 and March 2014, whereas the zoomed out view in FIG. 3(B) shows a timeline between 2011 and 2014.

When zooming into or out of the timeline, a timescale shown in the timeline displayed across a first dimension may be changed based on the adjusted start and end dates of the timeline. For example, in FIG. 2 the primary timescale 211 displays one year, whereas the primary timescale in FIG. 3B displays multiple years.

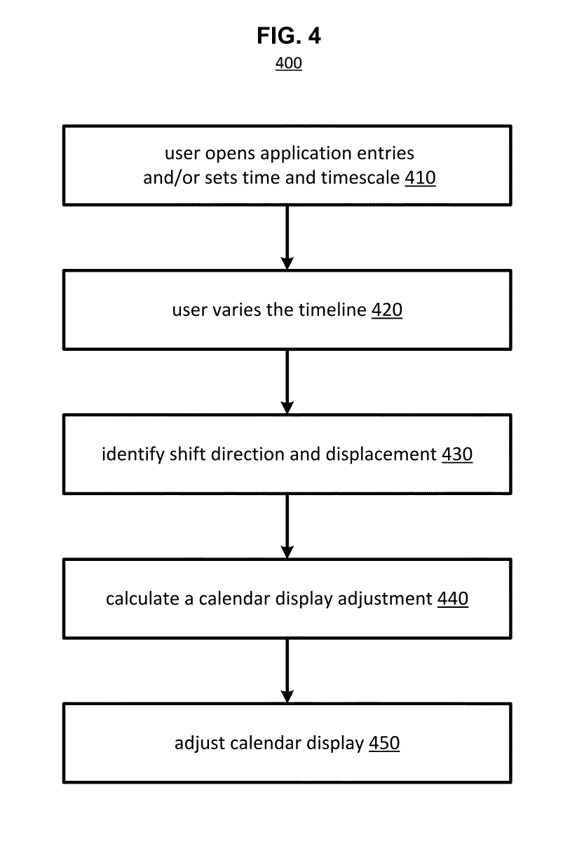

FIG. 4 illustrates a method for navigating the timeline illustrated by a customer management application according to an example embodiment of the present invention.

At step 410, a user opens a customer management application at a time position and timescale. Examples of the initial time position include today's date or the last date viewed by the user. In yet another example, the initial time position may be the time and timescale viewed when the application is opened via another application such as e-mail. Similarly, the initial timescale may be a day, week, or the timescale last viewed by the user. As described below, the customer management application may depict a timeline with a primary timescale (e.g., years) and a more granular secondary timescale (e.g., months). Event entries occurring within the depicted time period are displayed by the customer management application. As desired, the user may add, remove, or modify event entries.

Initially, the customer management application may require that a user provide a login name and login password to access the customer management application. The login name and login password may then be used to identify individual users associated with a customer management application. Optionally, the customer management application may be linked to an e-mail application such that event entries may also be added via the e-mail application.

At step 420, the user varies the timeline. For example, the time period and/or time scaled may be varied by zooming in or out. Next, at step 430, the customer management application identifies the shift direction (e.g., forward in time, back in time, more granular timescale, less granular timescale) and displacement (i.e., degree of change). Variations to the shift direction and displacement may be collectively referred to as “shift.” As discussed above, a variety of input/output devices may be implemented in the electronic device, such as a touchscreen, a gyroscopic, other acceleration device, keyboard, mouse, etc.

At step 440, a timeline display adjustment is calculated based on the detected shift. The timeline display adjustment can be calculated in three steps. First, a shift factor may be calculated. For example, the shift factor may be determined by dividing the shift displacement by the width of the timeline display if the shift is in the horizontal direction. Similarly, the shift factor may be determined by dividing the shift displacement by the height of the timeline display if the shift is in the vertical direction. Second, the shift factor may be multiplied by a factor representing a number of days or number of entries to determine a change to the number of days or entries illustrated by the customer management application. Third, the result can be compared to a threshold, and updates to the time position and/or timescale may be triggered when the predetermined threshold has been bypassed.

The customer management application may also include a preferences menu that enables a user to define customized thresholds with conditions when they may be applied. Alternatively, the customer management application may provide some pre-defined thresholds that may also be applied by a user. If desired, a threshold may be applicable for certain types of event entries. For example, the threshold applied when viewing a specific entry may be different than the threshold used when viewing a monthly timeline. In another example, a user may desire to use the motion features to navigate the timescale, but not to navigate individual entries. In yet another example, the threshold may be applied to navigate between multiple applications. In this last example, if a user opens another application, such as e-mail, via the customer management application, a motion may be detected and compared to a threshold to return to the customer management application.

The step of setting one or more customized thresholds may be performed initially when installing or first using the customer management application. Afterwards, a user may change the thresholds, as desired.

Lastly, at step 450, the user display of the customer management application is updated to display the adjusted time position and timescale. The timescale (i.e., primary and secondary) of the customer management application is adjusted to reflect a user's desired start and end dates. Optionally, the customer management application may check whether the start date or end date of the updated timescale deviates from a customized threshold (e.g., original timescale). If the user navigates too much, the start and end dates of the customer management application can be readjusted to the original dates or set to minimal date range. The minimal date range can be customized to include any number of days as desired. Thus, a customer management application that allows a user to easily navigate a customer management application is provided.

Accordingly, a customer management application that allows a user to navigate time position and timescale by manipulating an electronic device is provided. The user navigates the customer management application causing the time and timescale illustrated by a timeline display to change. Typically, a user can open the customer management application to view and/or and modify (add, delete, change, etc.) one or more event entries. In addition, after opening the customer management application, a user may navigate the timeline and vary the timescale illustrated by the customer management application. For example, a user may desire to view several entries that are scattered in time. In the case of a touch screen, the time shown may be changed by sliding a point or finger across the timeline illustrated on the screen. Similarly, the timescale may be changed according to a change of a distance separating two user selected points on the screen as at least one of the user selected points is moved by the user. In the case of an acceleration device, the time position may be changed according to detected variations in tilt. Similarly, the timescale may be changes by varying the device height. As the user zooms into and out of the timeline, a timescale that is displayed as part of the timeline may also be updated.

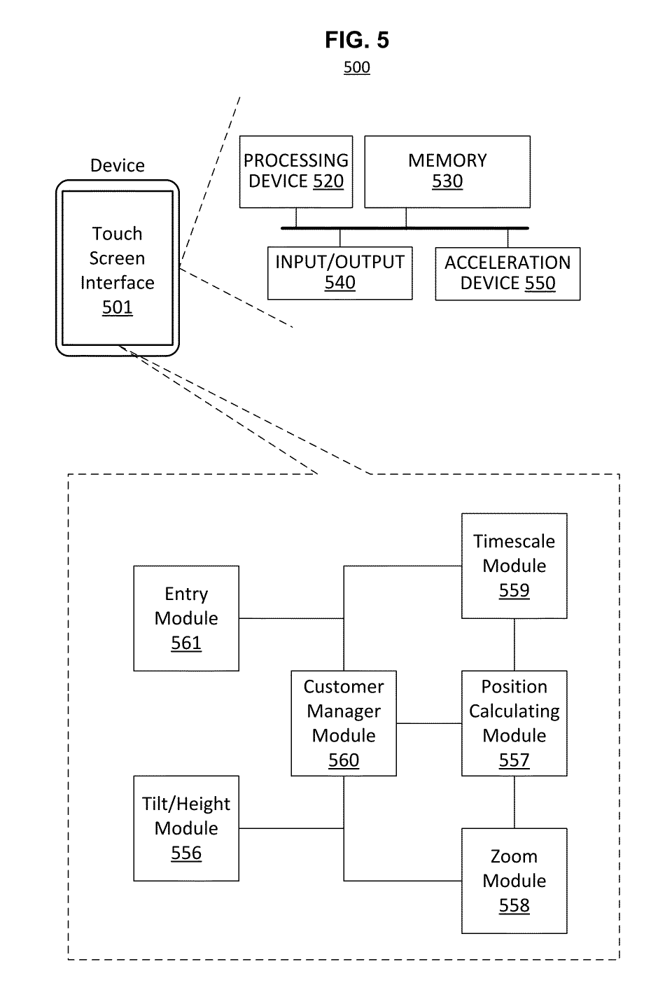

FIG. 5 illustrates a representative architecture of an electronic device according to an example embodiment of the present invention.

An electronic device 500 may include a touchscreen interface 501, processing device 520, memory 530, communications interface 540, and acceleration device 550. The touchscreen interface 501 may include a display, which may be a touchscreen, capable of displaying data to a user of the electronic device 500.

Although not shown, the touchscreen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Electronic device 500 may also include a customer manager module 560 that generally implements the functionality of the customer management application. Customer manager module 560 may be coupled to other modules including entry module 561, tilt and height module 556, position calculating module 557, zoom module 558, and a timescale module 559. Each of the modules may be part of the customer management application, or alternatively, may be part of another application and accessed by the customer management application. For example, the position calculating module 557 is coupled to zoom module 558, both of which may be shared by a variety of applications using the touchscreen interface 501.

Memory 530 may include a computer readable medium storing application modules, which may include instructions associated with applications and modules of the electronic device 500.

The position calculation module 557 may include functionality for identifying a touched first point and second point within a customer management application displaying a timeline across a first dimension on the touch screen device 500. The position calculation module 557 may also include functionality for calculating a change in a distance between the first point and the second point in response to a dragging of at least one of the touched points, scaling the calculated change in distance with a scaling factor that varies for different units of time in the customer management application, and dividing the scaled calculated change in distance by the width of the displayed timeline and by an adjustment factor to calculate a date change amount.

Tilt and height module 556 may include a gyroscopic or other acceleration device that identifies the shift direction (e.g., right, left, up, down) and displacement (i.e., degree of change). Tilt and height module 556 is operable to detect changes in the device's shift direction and displacement, scaling the detected a scaling factor that varies for different units of time in the customer management application, and dividing the scaled calculated change in distance by the width of the displayed timeline and by an adjustment factor to calculate a date change amount. In addition, the tilt and height module 556 can be used to perform related calculations, such as the shift angle and/or the height difference between the center of a portable electronic device and the lowest edge.

The zoom module 558 may include functionality for identifying whether the dragging corresponds to a zooming in or a zooming out based on the calculated distance change. The zoom module 558 may also include functionality for adjusting a start date and an end date of the displayed timeline by the calculated date change amount according to whether the dragging is identified as corresponding to the zooming in or the zooming out.

The timescale module 559 may include functionality for changing a timescale shown in the timeline displayed across the first dimension based on the adjusting of the start date and the end date.

The device 500 may contain a processing device 520, memory 530, and a communications device 540, all of which may be interconnected via a system bus. In various embodiments, the electronic device 500 may have an architecture with modular hardware and/or software systems that include additional and/or different systems communicating through one or more networks via communications device 540.

Communications device 540 may enable connectivity between the processing devices 520 in the device 500 and other systems by encoding data to be sent from the processing device 520 to another system over a network and decoding data received from another system over the network for the processing device 520.

In an embodiment, memory 530 may contain different components for retrieving, presenting, changing, and saving data and may include computer readable media. Memory 530 may include a variety of memory devices, for example, Dynamic Random Access Memory (DRAM), Static RAM (SRAM), flash memory, cache memory, and other memory devices. Additionally, for example, memory 530 and processing device(s) 520 may be distributed across several different computers that collectively comprise a system. Memory 530 may be capable of storing user inputs and preferences as well as customized sequences.

In some instances, a cache in memory 530 may store calculated changes to the distance between the first point and the second point during the dragging of at least one of the points. Similarly, the memory 530 may be accessed to store parameters of the tilt and height module 556. The zoom module 558 may then adjust the start date and the end date of the customer management application only after a stored calculated change in the cache exceeds a threshold value.

Processing device 520 may perform computation and control functions of a system and comprises a suitable central processing unit (CPU). Processing device 520 may include a single integrated circuit, such as a microprocessing device, or may include any suitable number of integrated circuit devices and/or circuit boards working in cooperation to accomplish the functions of a processing device. Processing device 520 may execute computer programs, such as object-oriented computer programs, within memory 530.

The foregoing description has been presented for purposes of illustration and description. It is not exhaustive and does not limit embodiments of the invention to the precise forms disclosed. For example, although the processing device 520 is shown as separate from the modules 557 to 559 and the touchscreen interface 501, in some instances the processing device 520 and the touchscreen interface 501 and/or one or more of the modules 557 to 559 may be functionally integrated to perform their respective functions.

Thus, systems and methods for timeline based visualization and handling of a customer are provided. According to the embodiments, data originating from multiple data sources may be aggregated and displayed on a single timeline display. Using the embodiments, an end user may quickly review the aggregated data, such as comprehensive data reflecting review of a client relationship. The embodiments may be adapted to interface with a variety of data sources including CRM and ERP systems.

It will be apparent to those skilled in the art that various modifications and variations can be made in the method and device for timeline based visualization and handling of a customer of the present invention without departing from the spirit or scope of the invention. Thus, it is intended that the present invention cover the modifications and variations of this invention provided they come within the scope of the appended claims and their equivalents.

We claim:

1. A method for navigating a customer management application hosted on an electronic device, the method comprising:
displaying, by a processor, a timeline having first and second timescales;
displaying, by the processor, one or more entries along the timeline, each of the entries containing one or more corresponding events;
detecting a user input through an input detector of the electronic device; and
upon detecting the user input, varying the timeline according to the user input,
wherein at least one of the entries includes aggregated data originating from internal and external backend data sources.

2. The method according to claim 1, further comprising calculating an importance value for each event corresponding to a selected entry.

3. The method according to claim 2, further comprising displaying the events according to their calculated importance value.

4. The method according to claim 1, further comprising displaying detailed information for a plurality of events corresponding to a selected entry.

5. The method according to claim 1, wherein the user input is detected by a touch screen.

6. The method according to claim 1, wherein the user input is detected by a gyroscopic or other acceleration device.

7. A non-transitory computer readable storage medium storing one or more programs configured to be executed by a processor of an electronic device, the one or more programs comprising instructions for:
displaying, by a processor, a timeline having first and second timescales;
displaying, by the processor, one or more entries along the timeline, each of the entries containing one or more corresponding events;
detecting a user input through an input detector of the electronic device; and
upon detecting the user input, varying the timeline according to the user input,
wherein at least one of the entries includes aggregated data originating from internal and external backend data sources.

8. The computer readable storage medium of claim 7, further comprising instructions for calculating an importance value for each event corresponding to a selected entry.

9. The computer readable storage medium of claim 8, further comprising instructions for displaying the events according to their calculated importance value.

10. The computer readable storage medium of claim 7, further comprising instructions for displaying detailed information for a plurality of events corresponding to a selected entry.

11. The computer readable storage medium of claim 7, wherein the user input is detected by a touch screen.

12. The method computer readable storage medium of claim 7, wherein the user input is detected by a gyroscopic or other acceleration device.

13. An electronic device comprising:
one or more processors; and
memory storing a plurality of integrated programs for execution by the one or more processors, one of the plurality of integrated programs including:
displaying a timeline having first and second timescales;
displaying one or more entries along the timeline, each of the entries containing one or more corresponding events;
detecting a user input through an input detector of the electronic device; and
upon detecting the user input, varying the timeline according to the user input,
wherein at least one of the entries includes aggregated data originating from internal and external backend data sources.

14. The electronic device according to claim 13, further comprising calculating an importance value for each event corresponding to a selected entry.

15. The electronic device according to claim 14, further comprising displaying the events according to their calculated importance value.

16. The electronic device according to claim 13, further comprising displaying detailed information for a plurality of events corresponding to a selected entry.

17. The electronic device according to claim 13, wherein the user input is detected by a touch screen.

18. The electronic device according to claim 13, wherein the user input is detected by a gyroscopic or other acceleration device.

19. A system comprising:
a plurality of backend data sources including internal and external backend data sources;
one or more intermediate servers adapted to aggregate data originating from the plurality of backend data sources;
a plurality of remote electronic devices, each of the remote electronic devices including:
one or more processors; and
memory storing a plurality of integrated programs for execution by the one or more processors, one of the plurality of integrated programs including:
displaying a timeline having first and second timescales;
displaying one or more entries along the timeline, each of the entries containing one or more corresponding events;
detecting a user input through an input detector of the electronic device; and
upon detecting the user input, varying the timeline according to the user input,
wherein at least one of the entries includes aggregated data originating from internal and external backend data sources.
